(19) United States
(12) Patent Application Publication
(10) Pub. No.: US 2008/0070546 A1
(43) Pub. Date: Mar. 20, 2008

(54) Emergency notification method and system using portable terminals

(75) Inventor: Moon Heui Lee, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/643,921

(22) Filed: Dec. 22, 2006

(30) Foreign Application Priority Data
Aug. 29, 2006 (KR) 2006-82149

(51) Int. Cl. H04M 11/04; G08B 5/22

(52) U.S. Cl. 455/404.2; 340/7.56; 340/539.1; 455/404.1; 340/7.5; 340/825.49; 340/539.13; 455/466; 455/457

(57) ABSTRACT

An emergency notification method and system using portable terminals are provided. The emergency notification method includes creating, by a sending portable terminal in response to detection of an emergency event, an emergency message and transmitting the created emergency message to a mobile communication system; forwarding, by the mobile communication system upon reception of the emergency message from the sending portable terminal, the emergency message to receiving portable terminals within a service area; and issuing, by each receiving portable terminal after reception of the emergency message from the mobile communication system, an emergency alert if necessary. Emergency information collected by one portable terminal is disseminated in real time to other portable terminals, which issue an alarm corresponding to the emergency information if necessary. As a result, terminal users can cope with an emergency in advance.

### CROSS-REFERENCE TO RELATED APPLICATIONS

This application claims the benefit under 35 U.S.C. §119(a) of Korean Patent Application filed in the Korean Intellectual Property Office on Aug. 29, 2006 and assigned Serial No. 2006-0082149, the entire disclosure of which is hereby incorporated by reference.

### BACKGROUND OF THE INVENTION

1. Field of the Invention

The present invention relates generally to a portable terminal. More particularly, the present invention relates to an emergency notification method and system using portable terminals, wherein information regarding an emergency is shared among multiple portable terminals and an emergency alert is automatically issued if necessary.

2. Description of the Related Art

Modern mobile communication systems support basic voice telecommunication services and various text messaging services, such as short message services (SMS), multimedia message services (MMS) and cell broadcasting services (CBS).

Advances in communication technologies have increased the popularity of portable terminals which have evolved into multifunction convergence terminals that have telecommunication and messaging functions and additional functions such as navigation.

A navigation system facilitates a portable terminal's ability to receive signals from satellites of a global positioning system (GPS) and to obtain the current location of the portable terminal by using the received signals. This allows a user carrying a navigation-equipped portable terminal to be aware of their current location, and to map out a path from the current location to a desired destination and obtain information on road conditions along the path.

However, such a navigation-equipped portable terminal cannot provide information on dynamic situations such as emergencies, car accidents, and road works.

Accordingly, there is a need for an improved system and method for providing an emergency notification through the use of portable terminals.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an emergency notification method and system using portable terminals, wherein emergency information collected by one portable terminal is disseminated to other portable terminals.

Another object of an exemplary embodiment of the present invention is to provide an emergency notification method and system using portable terminals, wherein an emergency message is automatically created and transmitted in response to input of a particular hotkey.

Another object of an exemplary embodiment of the present invention is to provide an emergency notification method and system using portable terminals. A portable terminal registers location data contained in a received emergency message and informs the user of the geographical location by issuing an emergency alarm when a user approaches a geographical location corresponding to the registered location data.

According to another object of an exemplary embodiment of the present invention, an emergency notification method and system using portable terminals is provided. A mobile communication system receives an emergency message from a portable terminal and forwards the emergency message to other portable terminals within a service area in a preset manner.

In accordance with an exemplary embodiment of the present invention, an emergency notification method using portable terminals is provided. An emergency message is created by a sending portable terminal in response to detection of an emergency event and the created emergency message is transmitted to a mobile communication system. The emergency message is forwarded to receiving portable terminals within a service area by the mobile communication system upon reception of the emergency message from the sending portable terminal. If necessary, an emergency alert is issued by each receiving portable terminal after reception of the emergency message from the mobile communication system.

In accordance with another exemplary embodiment of the present invention, there is provided an emergency notification method in a portable terminal. An emergency event is detected and current location data of the portable terminal is obtained and emergency information mapped to the emergency event is extracted. An emergency message containing the location data and emergency information is created and the created emergency message is transmitted to a mobile communication system.

In accordance with another exemplary embodiment of the present invention, an emergency notification method in a mobile communication system is provided. A determination is made as to whether a message received from a sending portable terminal is an emergency message. If the received message is an emergency message, the received message is forwarded as an emergency message to a plurality of portable terminals within a service area.

In accordance with another exemplary embodiment of the present invention, an emergency notification method in a portable terminal is provided. An emergency message is received from a mobile communication system. Emergency information and location data is extracted from the received emergency message. The extracted emergency information and location data is stored and current location data of the portable terminal is obtained. The obtained location data is compared with the stored location data and the stored emergency information is output if a difference between the obtained location data and the stored location data is less than a preset reference value.

In accordance with another exemplary embodiment of the present invention, there is provided an emergency notification system. A first portable terminal creates an emergency message in response to detection of an emergency event. The created emergency message is transmitted. Upon reception of the emergency message from the first portable terminal, a mobile communication system forwards the received emergency message to a plurality of second portable terminals within a service area, wherein each second portable terminal receives the emergency message, and issues an emergency alert if necessary.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 illustrates a configuration of an emergency notification system according to an exemplary embodiment of the present invention;

FIG. 2 illustrates transmission of emergency messages in the system of FIG. 1;

FIG. 3 illustrates a display screen representation of output of emergency information according to an exemplary implementation;

FIG. 4 illustrates a configuration of a portable terminal according to another exemplary embodiment of the present invention;

FIG. 5 is a flow chart illustrating steps in a transmission process of an emergency notification method according to another exemplary embodiment of the present invention; and

FIG. 6 is a flow chart illustrating steps in a reception process of the emergency notification method of FIG. 5.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In the description, the term ‘emergency message’ refers to any message that is generated by a portable terminal in response to detection of an emergency event (for example, input of a predetermined hotkey). An emergency message may be available through an SMS service, MMS service, electronic mail service, or moving image mail service.

According to an exemplary embodiment of the present invention, the mobile communication terminal is described as, but not limited to, a portable terminal. The portable terminal of an exemplary embodiment of the present invention is a terminal comprising a text messaging function. The portable terminal may be any information and communication appliance and multimedia appliance, such as a mobile communication terminal, digital broadcast reception terminal, personal digital assistant (PDA), smart phone, international mobile telecommunications 2000 (IMT 2000) terminal, wideband code division multiple access (WCDMA) terminal, and universal mobile telecommunications system (UMTS) terminal. The portable terminal may also be applied to applications which use any of the above described or similar devices.

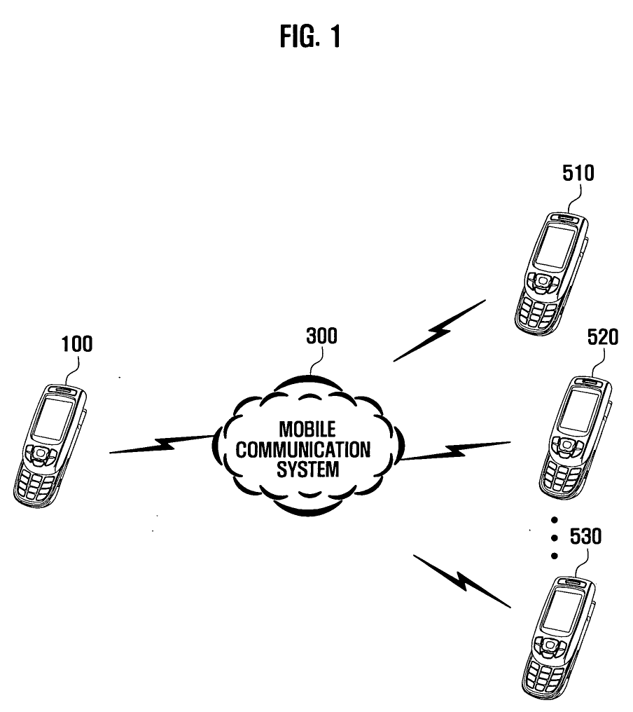

FIG. 1 illustrates a configuration of an emergency notification system according to an exemplary embodiment of the present invention.

Referring to FIG. 1, the emergency notification system includes a sending portable terminal 100, a mobile communication system 300, and a plurality of receiving portable terminals 510, 520 and 530. The sending portable terminal 100 creates an emergency message in response to input of a hotkey and transmits the emergency message to the mobile communication system 300. The mobile communication system 300 receives the emergency message from the sending portable terminal 100, and forwards the emergency message to the receiving portable terminals 510, 520 and 530 within a service area. Each of the receiving portable terminals 510, 520 and 530 receives the emergency message from the mobile communication system 300, and issues an alarm for a user if necessary.

The sending portable terminal 100 and the receiving portable terminals 510, 520 and 530 may utilize voice and wireless data communication services via the mobile communication system 300. A distinction between the sending portable terminal 100 and the receiving portable terminals 510, 520 and 530 is made for the purpose of description, and the portable terminals may have identical configurations and functions.

In response to detection of an emergency event (for example, input of a hotkey) from a sending user, the sending portable terminal 100 obtains current location data (for example, coordinate values in a coordinate system). The sending portable terminal 100 then finds emergency information mapped to the event (for example, a car accident, road work or fire), creates an emergency message containing the location data and emergency information, and transmits the created emergency message to the mobile communication system 300. Emergency information and emergency messages are described in more detail later.

The sending portable terminal 100 may also automatically create and transmit an emergency message in response to an impact detection signal, for example due to a collision of a car. For example, when a car collision occurs, an airbag system in the car detects impact due to the car collision and sends an impact detection signal to the sending portable terminal 100. The sending portable terminal 100 automatically creates an emergency message containing emergency information mapped to the signal (for example, car accident), and transmits the emergency message to the mobile communication system 300 upon reception of the impact detection signal.

The sending portable terminal 100 may include a GPS receiver to obtain geographical location data. That is, the sending portable terminal 100 receives signals from GPS satellites through the GPS receiver, and obtains the current geographical location using the received signals.

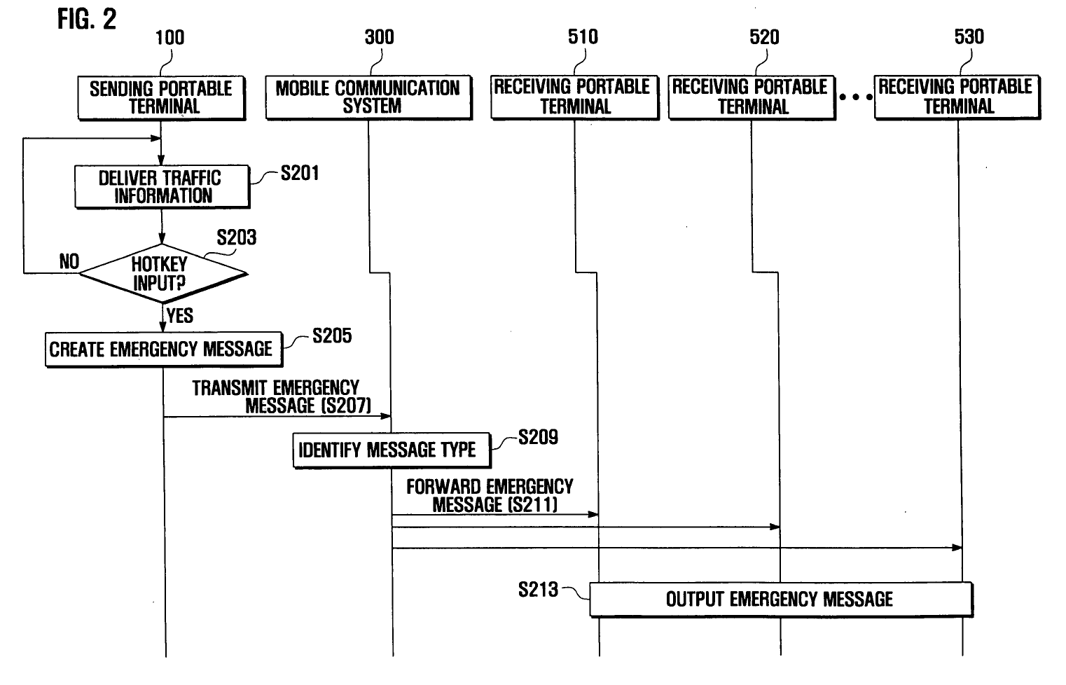

Upon reception of an emergency message from the sending portable terminal 100, the mobile communication system 300 forwards the emergency message to the receiving portable terminals 510, 520 and 530 within a service area. This emergency message forwarding is described below in relation to FIG. 2.

The mobile communication system 300 may include a base station (BS), base station controller (BSC), mobile switching center (MSC), home location register (HLR), and various information providing servers such as servers for a message service center, mobile broadcasting service (MBS), and cell broadcasting service (CBS).

The mobile communication system 300 provides communication channels for transmission of voices, data and messages between the sending portable terminal 100 and the receiving portable terminals 510, 520 and 530.

The communication channels may be established by one or a combination of the following communication technologies: code division multiple access (CDMA), frequency division multiple access (FDMA), time division multiple access (TDMA), WCDMA, UMTS, orthogonal FDMA (OFDMA), and Portable Internet such as wireless broadband (WiBro).

Each receiving portable terminal 510, 520 or 530 extracts and stores location data and emergency information from the received emergency message once an emergency message from the mobile communication system 300 is received. Thereafter, each receiving portable terminal 510, 520 or 530 periodically compares its current geographical location data with the stored location data, and issues an alarm corresponding to the stored emergency information if the difference between its current location data and the stored location data is less than a preset reference value (namely, when a portable terminal is near a notified emergency location). An emergency alarm may be issued by using a map, a sound or a text.

According to an exemplary implementation, each receiving portable terminal 510, 520 or 530 may include a GPS receiver to identify the geographical location. That is, each receiving portable terminal 510, 520 or 530 receives signals from GPS satellites through the GPS receiver, and obtains the current geographical location using the received signals.

FIG. 2 illustrates transmission of emergency messages in the emergency notification system. In FIG. 2, the sending portable terminal 100 transmits an emergency message related to traffic conditions during delivery of traffic information using a GPS. Emergency messages may also be related to other emergencies such as fires, among others.

Referring to FIG. 2, the sending portable terminal 100 delivers traffic information (for example, road conditions and speed limits) using a GPS (S201).

During delivery of traffic information, the sending portable terminal 100 determines whether a hotkey is input (S203). In the exemplary embodiment of the present invention, a plurality of numeric keys or shortcut keys may be assigned as hotkeys. Different emergency information may be mapped to different hotkeys or to different ‘press and hold’ modes of a single hotkey.

In FIG. 2, emergencies relate to traffic factors affecting traffic in a particular road section such as traffic conditions, accidents, and road works. Emergencies may also relate to other kinds of factors such as fires according to user settings. Example mappings between hotkeys and emergency information are illustrated in Table 1 and Table 2.

TABLE 1

| Key | Hotkey | Emergency | Location |
|---|---|---|---|
| 1 | hotkey-1 | accident | obtain |
| 2 | hotkey-2 | road work | current |
| 3 | hotkey-3 | normal | location |
| 4 | hotkey-4 | congestion | |
| 5 | hotkey-5 | user defined | |

TABLE 2

| Hotkey | Press & hold | Emergency | Location |
|---|---|---|---|
| volume | up short | accident | obtain |
| keys | up long | road work | current |
| | down short | normal | location |
| | down long | congestion | |
| | up/down successive | user defined | |

In Table 1, numeric keys are assigned as hotkeys, and emergency information is mapped to the hotkeys. In Table 2, volume keys are assigned as hotkeys, and emergency information is mapped to ‘press and hold’ modes of the hotkeys. Other hotkey assignments and emergency mappings are also possible.

If a hotkey is determined to be input at step S203, the sending portable terminal 100 creates an emergency message (S205) and transmits the created emergency message to the mobile communication system 300 (S207). At step S205, the sending portable terminal 100 discovers emergency information mapped to the input hotkey by using Table 1 or Table 2. The sending portable terminal 100 then obtains its current geographical location data.

Current location data of a portable terminal may be obtained using data from a corresponding base station or a GPS. According to an exemplary implementation, the sending portable terminal 100 obtains its location data using received GPS signals. The sending portable terminal 100 creates an emergency message that contains the discovered emergency information and obtained location data.

The emergency message may be any message available in a portable terminal through an SMS service, MMS service, electronic mail service, or moving image mail service.

In addition to emergency information (for example, car accident) and geographical location data (for example, coordinate values of a location), the emergency message may contain an identifier indicating the message type in a message header thereof.

According to an exemplary implementation, the created emergency message is transmitted in a coded form at step S207. The emergency message may also be transmitted to a particular recipient using a recipient phone number.

If the input hotkey is mapped to emergency information on a user-defined emergency, the sending portable terminal 100 displays an emergency message input box containing current location data on a screen to facilitate the sending user's ability to compose an emergency message.

Upon reception of the emergency message from the sending portable terminal 100, the mobile communication system 300 determines whether the received message is an emergency message, by verifying an identifier of the message header (S209). If the received message is an emergency message, the mobile communication system 300 forwards the emergency message to the receiving portable terminals 510, 520 and 530 within a service area (S211).

At step S211, the mobile communication system 300 may forward the emergency message using an SMS service, MMS service, mobile broadcasting service, and cell broadcasting service.

When a recipient phone number is present in the emergency message, the mobile communication system 300 may forward the emergency message to a portable terminal comprising the recipient phone number using an SMS or MMS service through unicast transmission.

The mobile communication system 300 may forward the emergency message to those portable terminals that have subscribed to the mobile broadcasting service through multicast transmission by using a mobile broadcasting service.

The mobile communication system 300 may forward the emergency message to all portable terminals within a service area through broadcast transmission by using a cell broadcasting service.

Each receiving portable terminal 510, 520 or 530 receives the emergency message from the mobile communication system 300, and outputs the received emergency message (S213).

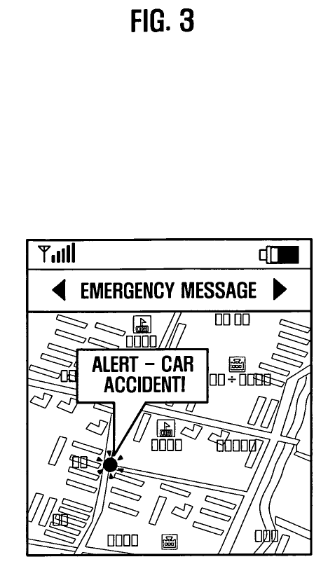

At step S213, each receiving portable terminal 510, 520 or 530 determines whether the received message is an emergency message. If the received message is an emergency message, each receiving portable terminal 510, 520 or 530 extracts location data and emergency information from the received emergency message and stores the extracted location data and emergency information. Thereafter, each receiving portable terminal 510, 520 or 530 periodically obtains its current location data and compares the obtained location data with the stored location data, and issues an alarm corresponding to the stored emergency information if the difference between the obtained location data and the stored location data is less than a preset reference value. FIG. 3 illustrates a display screen representation of an output of emergency information. The emergency alarm may be issued using a map, message, or sound. The location indicated by the stored location data may be marked on a map, an alert message corresponding to the stored emergency information may be displayed, or a speech sound may be output.

A single portable terminal in a service area may receive the emergency message depending on the transmission modes of the mobile communication system 300 (for example, unicasting, multicasting and broadcasting). A portion or all portable terminals in a service area may also receive the emergency message.

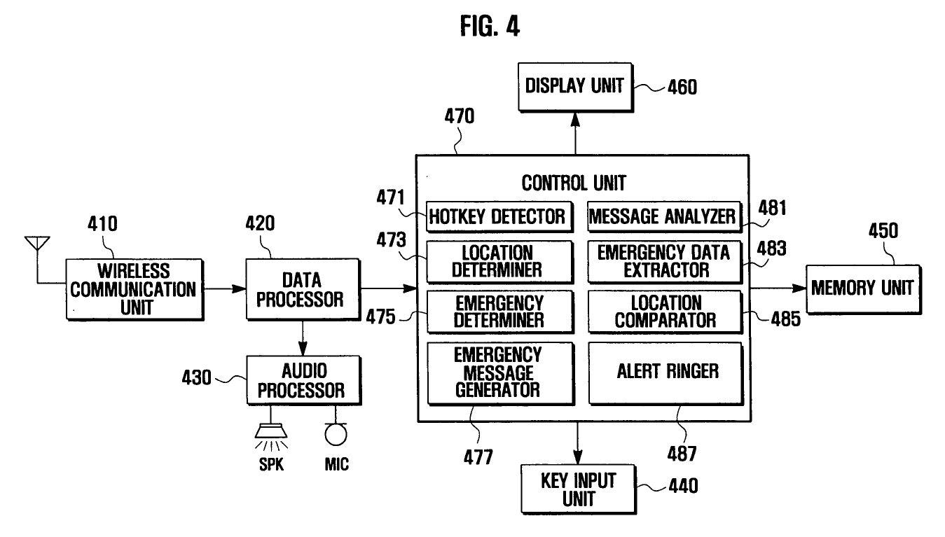

FIG. 4 illustrates a configuration of a portable terminal according to another exemplary embodiment of the present invention. The portable terminal may function as a sending portable terminal or as a receiving portable terminal in FIGS. 1 and 2.

When the portable terminal functions as a sending portable terminal, in response to input of a hotkey, the portable terminal creates an emergency message containing emergency information mapped to the hotkey and current location data, and transmits the created emergency message to a mobile communication system.

When the portable terminal functions as a receiving portable terminal, the portable terminal receives an emergency message from the mobile communication system, extracts emergency information and location data from the received emergency message, and, if necessary, marks a location indicated by the extracted location data on a map and issues an alert corresponding to the extracted emergency information.

Referring to FIG. 4, the portable terminal includes a wireless communication unit 410, a data processor 420, an audio processor 430, a key input unit 440, a memory unit 450, a display unit 460, and a control unit 470. The control unit 470 includes a hotkey detector 471, a location determiner 473, an emergency determiner 475, an emergency message generator 477, a message analyzer 481, an emergency data extractor 483, a location comparator 485, and an alert ringer 487.

The wireless communication unit 410 establishes communication channels to a corresponding mobile communication system, for transmission and reception of voice and data signals (for example, emergency messages). The wireless communication unit 410 may include a radio frequency (RF) transmitter and an RF receiver. The RF transmitter upconverts the frequency of a signal to be transmitted and amplifies the signal. The RF receiver low-noise amplifies a received signal and downconverts the frequency of the received signal.

The data processor 420 processes audio data to and from the audio processor 430, alphanumeric data from the key input unit 440, and voice and other user data to and from the wireless communication unit 410. The data processor 420 also processes an audio signal corresponding to emergency information (for example, an audible alarm or alert speech message). The data processor 420 encodes and modulates a signal to be transmitted through the wireless communication unit 410, and demodulates and decodes a signal received through the wireless communication unit 410. Thereto, the data processor 420 may include a modulator/demodulator (modem) and a coder/decoder (codec). The codec includes a data codec for packet data processing, and an audio codec for audio signal processing.

The audio processor 430 reproduces an audio or acoustic signal from the data processor 420 through a speaker SPK, and transmits an audio signal such as a voice signal input from a microphone MIC to the data processor 420.

The key input unit 440 includes numeric, character and function keys for inputting numeric and character information and for setting and performing various functions. The function keys include direction keys, volume keys, shortcut keys and hotkeys to perform corresponding functions. The key input unit 440 receives a key signal from a user for setting or controlling a function of the portable terminal, and sends the received key signal to the control unit 470.

The memory unit 450 stores application programs and associated data for operating the portable terminal, and user data resulting from user input or from reception of external data. The memory unit 450 may include one or more buffer areas for temporarily storing user data resulting from execution of the application programs.

The memory unit 450 includes a program memory section and a data memory section. The program memory section stores the operating system (OS) for overall control of the portable terminal, and application programs for performing functions related to hotkey detection, emergency message generation, current location determination, alert ringing according to notified emergencies, and map display. The program memory section further stores application programs for performing optional functions related to, for example, camera photographing, audio reproduction, and image or video reproduction. In response to a user request for activating a particular function, the portable terminal executes a corresponding function of the application programs.

The data memory section stores user data resulting from the use of the portable terminal. The user data may include images, videos, phonebook data, audios, maps, location data, and emergency messages. The user data and associated setting data may be stored in a database.

The display unit 460 displays various data, such as menus, user input data, maps, alert messages related to emergencies, function setting data, and data to be delivered to a user. The display unit 460 may include a liquid crystal display (LCD) screen. If the LCD screen has a touch screen capability, the display unit 460 may act as an input means.

The control unit 470 controls the overall operation of the portable terminal. The control unit 470 controls exchange of signals between the wireless communication unit 410, data processor 420, audio processor 430, key input unit 440, memory unit 450, and display unit 460. The control unit 470 may include the data processor 420.

According to an exemplary implementation, the control unit 470 controls generation and transmission of emergency messages, and controls reception of emergency messages and output of emergency alerts corresponding to notified emergencies. The control unit 470 includes the hotkey detector 471, location determiner 473, emergency determiner 475, and emergency message generator 477 to control generation and transmission of an emergency message. The control unit 470 also includes the message analyzer 481, emergency data extractor 483, location comparator 485, and alert ringer 487 to control reception of an emergency message and output of an emergency alert.

The hotkey detector 471 detects input of a hotkey by a user. Hotkeys are used to generate emergency messages, and are described previously in relation to FIG. 2.

The location determiner 473 obtains current location data of the portable terminal after an input hotkey has been detected by the hotkey detector 471. The current location data can be obtained using signals from a corresponding base station or GPS satellites.

The emergency determiner 475 finds emergency information mapped to the input hotkey. Mappings between hotkeys and emergencies are described previously in relation to Tables 1 and 2.

The emergency message generator 477 creates an emergency message containing the location data obtained by the location determiner 473 and the emergency information found by the emergency determiner 475.

After emergency message creation, the control unit 470 controls transmission of the emergency message to the mobile communication system.

The message analyzer 481 analyzes a message from the mobile communication system to determine whether the received message is an emergency message, by, for example, verifying a message identifier in a header part of the received message. If the received message is an emergency message, the message analyzer 481 outputs the received message as an emergency message to the emergency data extractor 483.

The emergency data extractor 483 extracts emergency information and location data from the emergency message, and stores the extracted emergency information and location data in the memory unit 450.

The location comparator 485 periodically compares current location data of the portable terminal with the stored location data to calculate the distance to a geographical location indicated by the stored location data. The location determiner 473 obtains current location data upon reception of the emergency message and thereafter if necessary. The location determiner 473 also outputs the obtained location data to the location comparator 485. If the difference between the current location data and the stored location data is less than a preset reference value, the location comparator 485 outputs the comparison result to the alert ringer 487.

The alert ringer 487 issues an emergency alarm using the stored emergency information and location data in response to reception of the comparison result from the location comparator 485.

Although not shown in FIG. 4, the portable terminal of an exemplary embodiment of the present invention may further include a GPS receiver, a camera module, or a digital broadcast receiver.

Although the portable terminal shown in FIG. 4 creates and transmits an emergency message in response to input of a hotkey by a user, the portable terminal may further include an event detector and may therewith automatically create and transmit an emergency message in response to detection of an event. For example, when an airbag system in a car detects impact due to a car collision and sends an impact detection signal to the event detector of the portable terminal, an emergency message corresponding to a car accident can be automatically created and transmitted.

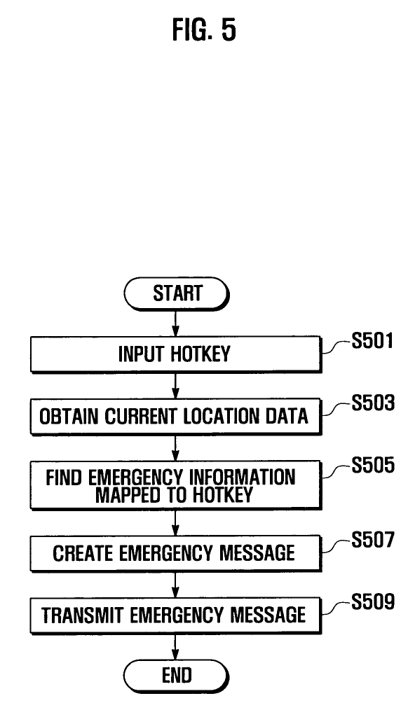

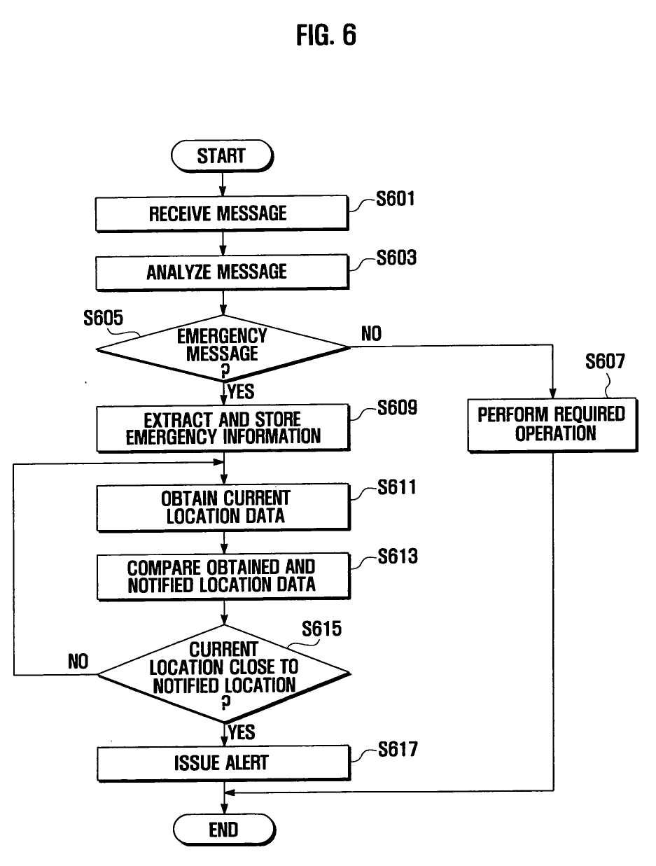

An emergency notification method, according to another exemplary embodiment of the present invention, is described in relation to FIGS. 5 and 6.

FIG. 5 is a flow chart illustrating steps in a transmission process of the emergency notification method.

Referring to FIG. 5, a portable terminal determines that a hotkey is input (S501). When a hotkey is input, the portable terminal obtains current location data (S503), and finds emergency information mapped to the input hotkey (S505). Mappings between emergencies and hotkeys are described in relation to Tables 1 and 2.

The portable terminal creates an emergency message containing the obtained location data and found emergency information (S507), and transmits the created emergency message to a mobile communication system (S509). The emergency message may be any message available in the portable terminal through an SMS service, MMS service, electronic mail service, or moving image mail service. In addition to emergency information and geographical location data, the emergency message may contain an identifier indicating the message type in a message header.

In FIG. 5, the portable terminal creates and transmits an emergency message in response to input of a hotkey by a user. However, the portable terminal may also automatically create and transmit an emergency message in response to input of an impact detection signal, for example due to a car collision.

FIG. 6 is a flow chart illustrating steps in a reception process of the emergency notification method.

Referring to FIG. 6, when a message is received (S601), the portable terminal analyzes the received message (S603), and determines whether the received message is an emergency message by verifying an identifier in the message header (S605).

If the received message is not an emergency message, the portable terminal performs a necessary message handling operation such as message display (S607).

If the received message is an emergency message, the portable terminal extracts emergency information and location data from the received message, and stores the extracted emergency information and location data (S609).

The portable terminal periodically obtains current location data (S611), and compares the obtained location data with the stored location data (S613).

The portable terminal determines whether the difference between the obtained location data and the stored location data is less than a preset reference value (S615). If the difference is less than the preset reference value, the portable terminal issues an emergency alarm (S617). The emergency alarm is issued using the stored emergency information and location data, and is described in relation to FIG. 3.

As apparent from the above description, an exemplary embodiment of the present invention provides an emergency notification method and system using portable terminals wherein emergency information collected by one portable terminal is disseminated in real time to other portable terminals. In an emergency, when a user enters a hotkey of a portable terminal associated with the emergency, the-portable terminal automatically creates an emergency message containing information on the emergency and current location, and transmits the emergency message to other portable terminals within a particular geographical area. Each portable terminal that receives the emergency message issues an alarm if the distance from the portable terminal to the notified emergency location is less than a preset distance. As a result, terminal users can cope with an emergency in advance.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An emergency notification method, comprising:
creating, by a sending portable terminal in response to detection of an emergency event, an emergency message and transmitting the created emergency message to a mobile communication system;
forwarding, by the mobile communication system upon reception of the emergency message from the sending portable terminal, the emergency message to at least one receiving portable terminal within a service area; and
issuing, by the at least one receiving portable terminal after reception of the emergency message from the mobile communication system, an emergency alert.

2. The emergency notification method of claim 1, wherein the emergency event comprises at least one of a key input event and an impact detection event.

3. The emergency notification method of claim 1, wherein the created emergency message comprises emergency information mapped to the emergency event and location data of the sending portable terminal at the time of the emergency event detection.

4. The emergency notification method of claim 1, wherein the creating comprises the sending portable terminal transmitting the created emergency message using at least one of a short message service and a multimedia message service.

5. The emergency notification method of claim 1, wherein the forwarding comprises the mobile communication system forwarding the emergency message using at least one of a short message service, multimedia message service, mobile broadcasting service, and cell broadcasting service.

6. The emergency notification method of claim 1, wherein the forwarding comprises the mobile communication system forwarding the emergency message through at least one of a unicast, multicast, and broadcast transmission.

7. The emergency notification method of claim 3, wherein the issuing of the emergency alert comprises:
extracting emergency information and location data from the received emergency message and storing the extracted emergency information and location data;
obtaining current location data of the receiving portable terminal; and
issuing an emergency alert if a difference between the obtained location data and the stored location data is less than a reference value.

8. An emergency notification method, comprising:
detecting an emergency event;
obtaining current location data of a portable terminal and extracting emergency information mapped to the emergency event; and
creating an emergency message comprising the location data and emergency information, and transmitting the created emergency message to a mobile communication system.

9. The emergency notification method of claim 8, wherein the emergency event comprises at least one of a key input event and an impact detection event.

10. The emergency notification method of claim 8, wherein the emergency message is created and transmitted using at least one of a short message service and a multimedia message service.

11. An emergency notification method, comprising:
determining whether a message received from a sending portable terminal comprises an emergency message; and
forwarding, if the received message comprises the emergency message, the received message to a plurality of portable terminals within a service area.

12. The emergency notification method of claim 11, wherein the emergency message comprises emergency information and location data of the sending portable terminal.

13. The emergency notification method of claim 11, wherein the forwarding comprises the emergency message using at least one of a short message service, multimedia message service, mobile broadcasting service, and cell broadcasting service.

14. The emergency notification method of claim 11, wherein the forwarding comprises forwarding the emergency message is forwarded through at least one of unicast, multicast, and broadcast transmission.

15. An emergency notification method in a portable terminal, comprising:
receiving an emergency message from a mobile communication system;
extracting emergency information and location data from the received emergency message and storing the extracted emergency information and location data;
obtaining current location data of the portable terminal;
comparing the obtained location data with the stored location data; and
outputting an emergency alert if a difference between the obtained location data and the stored location data is less than a reference value.

16. The emergency notification method of claim 15, wherein the outputting comprises:
displaying a map of a geographical area corresponding to the obtained location data and stored location data on a screen;
marking a location corresponding to the stored location data on the map; and
displaying the stored emergency information on the map.

17. An emergency notification system comprising:
a first portable terminal for creating, in response to detection of an emergency event, an emergency message and for transmitting the created emergency message; and
a mobile communication system for forwarding, upon reception of the emergency message from the first portable terminal, a received emergency message to a plurality of second portable terminals within a service area,
wherein each second portable terminal receives the emergency message, and issues an emergency alert.

18. The emergency notification system of claim 17, wherein the emergency event comprises at least one of a key input event and an impact detection event.

19. The emergency notification system of claim 17, wherein the created emergency message comprises emergency information mapped to the emergency event and location data of the first portable terminal at the time of the emergency event detection.

20. The emergency notification system of claim 17, wherein the first portable terminal transmits the created emergency message to the mobile communication system using at least one of a short message service and a multimedia message service.

21. The emergency notification system of claim 17, wherein the mobile communication system forwards the emergency message using at least one of a short message service, multimedia message service, mobile broadcasting service, and a cell broadcasting service.

22. The emergency notification system of claim 17, wherein the mobile communication system forwards the emergency message through at least one of unicast, multicast, and broadcast transmission.

23. The emergency notification system of claim 17, wherein the first portable terminal comprises:
a hotkey detector for detecting input of a hotkey;
a location determiner for obtaining, in response to the hotkey input, current location data of the first portable terminal;
an emergency determiner for finding emergency information mapped to the hotkey; and
an emergency message generator for creating an emergency message comprising the obtained location data and found emergency information.

24. The emergency notification system of claim 17, wherein at least one second portable terminal comprises:
a message analyzer for analyzing a received message to determine whether the received message comprises an emergency message, and for outputting, if the received message is an emergency message, the received message as an emergency message;
an emergency data extractor for extracting emergency information and location data from the emergency message, and for storing the extracted emergency information and location data;
a location comparator for comparing obtained current location data of the second portable terminal with the stored location data, and for outputting the comparison result; and
an alert ringer for issuing an emergency alert corresponding to the stored emergency information and location data using the comparison result.

25. The emergency notification system of claim 24, wherein the location comparator calculates the distance between a first location corresponding to the obtained location data and a second location corresponding to the stored location data, and outputs the calculated distance.

26. The emergency notification system of claim 24, wherein the alert ringer displays a map of a geographical area corresponding to the obtained location data and stored location data on a screen, marks a location corresponding to the stored location data on the map, and displays the stored emergency information on the map.

27. The emergency notification system of claim 17, wherein each of the first and second portable terminals comprises:
a hotkey detector for detecting input of a hotkey;
a location determiner for obtaining current location data of the portable terminal;
an emergency determiner for finding emergency information mapped to the hotkey;
an emergency message generator for creating an emergency message to be sent comprising the obtained location data and found emergency information;
an emergency data extractor for extracting emergency information and location data from a received emergency message and storing the extracted emergency information and location data;
a location comparator for comparing newly obtained location data of the portable terminal with the stored location data, and outputting the comparison result; and
an alert ringer for issuing an emergency alert corresponding to the stored emergency information and location data using the comparison result.

28. An emergency notification method, comprising:
creating an emergency message and transmitting the created emergency message to a mobile communication system;
forwarding the emergency message to at least one receiving portable terminal within a service area; and
issuing an emergency alert.

29. The emergency notification method of claim 28, wherein the emergency message is created and transmitted by a sending portable terminal in response to detection of an emergency event.

30. The emergency notification method of claim 28, wherein the emergency message is forwarded to the at least one receiving portable terminal by the mobile communication system upon receipt of the emergency message from the sending portable terminal.

31. The emergency notification method of claim 28, wherein the emergency alert is issued by at least one receiving portable terminal after reception of the emergency message from the sending portable terminal.

32. An emergency notification system comprising:
a first portable terminal for creating an emergency message and for transmitting the created emergency message; and
a mobile communication system for forwarding a received emergency message to at least one second portable terminal within a service area,
wherein each second portable terminal receives the emergency message, and issues an emergency alert.

33. The emergency notification system of claim 32, wherein the emergency message is created in response to detection of an emergency event.

34. The emergency notification system of claim 32, wherein the received emergency message is forwarded when the emergency message is received from the first portable terminal.

35. The emergency notification method of claim 1, wherein the forwarding comprises forwarding to a plurality of mobile terminals, and the issuing comprises issuing, by each receiving portable terminal after reception of th emergency message from the mobile communication system, an emergency alert.

36. The emergency notification system of claim 17, wherein the forwarding comprises forwarding to a plurality of mobile terminals, and the issuing comprises issuing, by each receiving portable terminal after reception of the emergency message from the mobile communication system, an emergency alert.
